(19) United States
(12) Patent Application Publication
(10) Pub. No.: US 2006/0155787 A1
(43) Pub. Date: Jul. 13, 2006

(54) Method for the transmission of digital content via a mobile telephone network

(75) Inventors: Cedric Nicholas, Paris (FR); Stephane Smierzchalski, Paris (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: BOUYGUES TELECOM

(21) Appl. No.: 11/331,330

(22) Filed: Jan. 11, 2006

(30) Foreign Application Priority Data
Jan. 12, 2005 (FR) 0500290

(51) Int. Cl. H04N 7/16

(52) U.S. Cl. 707/204; 707/1; 725/62

(57) ABSTRACT

The invention relates to a method for downloading a digital content via a mobile telephone network, comprising a step consisting of associating marking data including a link, with the downloaded digital content, wherein the marking data are adapted to be recognised by a mobile terminal. The invention also relates to a method for transferring a content, comprising steps in which: when the user orders transfer of the content from the mobile terminal to another terminal, the mobile terminal recognises the marking data associated with the content, the mobile terminal transfers only the link associated with the content.

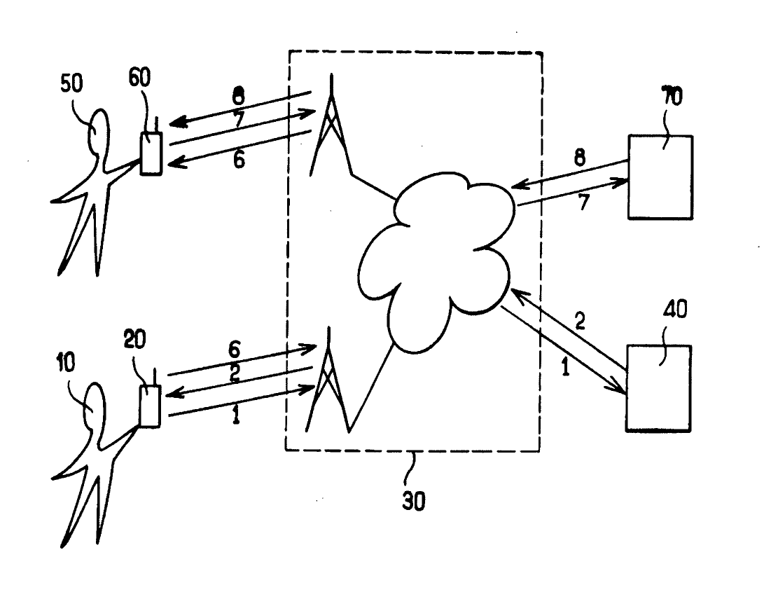

The invention concerns the field of mobile telephony.

More particularly, it concerns the exchanges of digital contents (images, ringtones, animations, programmes, documents, etc.) via a network of cellular mobile telephony.

Nowadays, super-distribution allows the transmission of contents from one user to another via a link between two terminals (cellular mobile telephones or communicating PDAs) connected to a mobile telephone network.

Digital rights management (DRM) has therefore become a concern for the content publishers who wish to safeguard the operating rights associated with this content.

In these conditions, the content publishers have been obliged to establish standards with a view to controlling the transfers of content between users.

For example, the OMA DRM 1.0 standard, published by the OMA (Open Mobile Alliance) describes content protection techniques. According to these techniques, the digital content transmitted by the content publishers can be marked with different levels of predetermined marking that can be recognised by certain mobile telephones.

The “forward-lock” technique consists of marking a content as being non-transferable. A content marked in this way cannot be transferred by one user to another.

The “combined delivery” technique is similar to “forward lock”, except that it also applies operating rules to the content.

The “separate delivery” technique consists of transmitting content separately in the form of encrypted files and of the associated operating rights. A user can transfer the content to another user, subject to prior acquisition of authorisation from the content publisher.

One aim of the invention is to propose a method that allows a user of a mobile terminal to transfer a digital content to another user under the control of the content publishers.

To this end, the invention proposes a method for downloading a digital content to a first mobile terminal via a mobile telephone network, the method comprising a step consisting of transmitting the digital content to the first mobile terminal, as well as marking data associated with the digital content, the marking data including a link. In this method, the marking data are adapted to be recognised by the mobile terminal, so that when a user of the first mobile terminal orders transfer of the content to a second terminal, the first mobile terminal transfers only the link associated with the content.

According to this method, a content publisher can mark digital content to indicate that this content is transferable by link. In other words, the digital content is associated with management rules according to which the content is not transferable in itself, and only the link associated with it can be transferred from one user to another.

The invention also proposes a method for transferring a digital content from a first mobile terminal to a second terminal, the digital content being associated with marking data including a link, comprising a step in which:

when a user orders the transfer of the content from the first mobile terminal to the second terminal, the first mobile terminal recognises the marking data associated with the content,

the first mobile terminal transfers only the link associated with the content to the second terminal.

With such a method, only the link associated with the digital content can be transferred from a first user to a second user.

The invention therefore proposes a technique which is intermediate between the marking techniques of previous designs and the transmission of content without marking.

In one implementation of the downloading method and of the transfer method, the marking data are written into the header of a file that includes the digital content.

In particular, the link can contain an URL address.

In one implementation of the downloading method and of the transfer method, when a user of the second terminal activates the link, the second terminal connects to a page for subscription to a content downloading service.

In one implementation of the downloading method and of the transfer method, when a user of the second terminal activates the link, the link triggers the downloading of content in low-quality form.

The invention also relates to a server for downloading a digital content, the server comprising means for associating marking data including a link, with the digital content, the marking data being adapted to be recognised by a mobile terminal, so that when a user of the mobile terminal orders transfer of the content from the first mobile terminal to another terminal, the mobile terminal transfers only the link associated with the content.

The invention also relates to a mobile telephone capable of downloading digital content with which marking data including a link, are associated, where the telephone mobile includes means for recognising the marking data associated with the content and, when a user orders the transfer of the content to another terminal, for transferring only the link associated with the content.

The mobile telephone can include means for saving the digital content, as well as the associated marking data.

Other characteristics and advantages will emerge from the description that follows, this description being purely illustrative and non-limitative, and should be read with reference to the single appended figure which schematically illustrates the different steps of a method for the transmission of content according to one possible method of implementation of this present invention.

The proposed transmission method includes a method for downloading a content and a corresponding method for transferring a content.

The content downloading method includes the following steps.

According to a first step, a first user 10 of a first mobile telephone 20 connects via the mobile telephone network 30 to a server 40. The server 40 is a server for the downloading of digital content managed by the content publisher. The contents proposed by the publisher can include video or music files for example.

The first mobile telephone 20 transmits to the server 40 a request to download a content chosen by the user 10 (arrow 1).

According to a second step, the server 40 processes the request that it receives and in return transmits to the mobile telephone 20 a file that includes the content and the associated marking data (arrow 2) via the mobile telephone network 30.

During this second step, the server 40 associates marking data with the content. To this end, the server 40 includes means for inserting the marking data into a header of the file that includes the content. This marking data includes information that can be recognised by the mobile telephone 20 indicating that the content can be transferred only by means of a substitution link, as well as the substitution link. The substitution link contains a URL (Universal Resource Locator address).

According to a third step, the mobile telephone 20 saves the file in its memory.

We will now assume that the first user 10 wishes to transfer the digital content that has just been downloaded to a second user 50. The second user 50 is equipped with a second mobile telephone 60.

The content transfer method includes the following steps.

According to a fourth step, the first user 10 orders the first mobile telephone 20 to transfer the content to the second mobile telephone 60. To this end, the first user 10 dials an MMS message or an e-mail for example, intended for the second user 50, and performs the operations necessary to attach, to the message, the content he wants to transfer.

When the first user 10 orders transfer of the content from the first mobile telephone 20 to the second mobile telephone 60, the first mobile telephone 20 recognises the marking data associated with the content.

The first mobile terminal 20 indeed is programmed to read the header of the file including the content, and to identify the marking data.

According to a fifth step, the first mobile telephone 20 displays a warning message indicating to the user 20 that the content cannot be transferred. The first mobile telephone 20 also displays a message proposing, to the first user 10, to transfer the link associated with the content.

The first user 10 can accept or reject the proposal.

According to a sixth step, if the first user 10 accepts the proposal, the first mobile telephone 20 transfers the message dialled by the first user 10 containing the link associated with the content (arrow 6) to the second mobile telephone 60 via the mobile telephone network 30.

The second user 50 is then able to select the link received.

According to a first option, the link contains a URL address that designates the location of the content in the server 40. In this case, when the second user 50 selects the link, the second mobile telephone 60 transmits a request to the server 40 to download the content. The second user 50 can thus obtain the content via the link received from the user 10, under the control of the content publisher.

According to a second option, the link contains a URL address of a page located in another server 70. This option enables the location of the digital content in the server 40 to be concealed from the second user 50.

In this case, when the second user 50 selects the link, the second terminal 60 connects to the server 70 (arrow 7).

The server 70 can propose to the second user 50 that he should subscribe to a content downloading service. If the second user 60 accepts that he should subscribe to the downloading service, he can then be connected to the content downloading server 40 to download the wanted content.

The server 70 can also transmit content in low-quality form to the second mobile telephone 60. The content in low-quality form can be composed, for example, of an extract from the digital content, or of the digital content with a reduced quality in relation to the original digital content. The content in low-quality form allows the user 50 to ascertain the content and then to decide whether he wishes to download it.

1. A method for downloading a digital content to a first mobile terminal (20) via a mobile telephone network (30), comprising transmitting the digital content to the first mobile terminal, as well as marking data associated with the digital content, the marking data including a link, wherein the marking data are adapted to be recognized by the first mobile terminal (20), so that when a user (10) of the first mobile terminal (20) orders the transfer of content to a second terminal (60), the first mobile terminal (20) transfers only the link associated with the content.

2. A method for transferring a digital content from a first mobile terminal (20) to a second terminal (60), the digital content being associated with marking data including a link, comprising the step in which:
when a user (10) orders transfer of the content from the first mobile terminal (20) to the second terminal (60), the first mobile terminal (20) recognizes the marking data associated with the content,
the first mobile terminal (20) transfers only the link associated with the content to the second terminal (60).

3. The method according to claim 1 or 2, wherein the marking data are written into the header of a file that includes the digital content.

4. The method according to claim 1 or 2, wherein the link contains a URL address.

5. The method according to claim 1 or 2, wherein when a user (50) of the second terminal (60) activates the link, the second terminal (60) connects to a page for subscription to a content downloading service.

6. The method according to claim 1 or 2, wherein when a user (50) of the second terminal (60) activates the link, the link triggers the downloading of a content in low-quality form.

7. A server (40) for downloading digital content, the server (40) comprising means for associating marking data including a link, with the digital content, the marking data being adapted to be recognized by a mobile terminal (20), so that when a user (10) of the mobile terminal (20) orders transfer of the content from the first mobile terminal (20) to another terminal (60), the mobile terminal (20) transfers only the link associated with the content.

8. A mobile telephone (20) capable of downloading a digital content with which marking data including a link, are associated, the mobile telephone (20) comprising means for recognizing the marking data associated with the content and, when a user (10) orders transfer of the content to another terminal (60), for transferring only the link associated with the content.

9. The mobile telephone (20) according to claim 8, comprising means for saving the digital content as well as the associated marking data.
